(19) United States
(12) Patent Application Publication
(10) Pub. No.: US 2018/0228320 A1
(43) Pub. Date: Aug. 16, 2018

(54) BATHTUB POST

(71) Applicant: John I. Andersen, Idaho Falls, ID (US)

(72) Inventor: John I. Andersen, Idaho Falls, ID (US)

(21) Appl. No.: 15/430,483

(22) Filed: Feb. 11, 2017

(51) Int. Cl. A47K 3/00; F16B 39/22

(52) U.S. Cl. CPC A47K 3/003; F16B 39/225

(57) ABSTRACT

A vertical post can increase bathtub safety by providing a hand-hold which can be installed permanently to many types of bathtubs. Embodiments include a vertical tubular section and a lag bolt at a bottom rotationally fixed to the tubular section. The vertical post can pass through a hole in the bathtub side and be anchored to the sub floor of the home under the bathtub.

### BACKGROUND

One potential injury to the elderly, to young children, and to other people can result from climbing in and out of a bathtub. Many bathtubs comprise a coating of porcelain enamel or have similar surfaces. Due to the properties of such bathtubs and the presence of water for bathing, many injuries occur as the person steps out of the bathtub and slips on a wet surface on the tub side. Likewise, many bathroom floors of tile, linoleum, or similar surfaces become slippery when wet and may cause people to slip and fall when stepping in or out of a bathtub.

Currently, there are many solutions provided in attempts to aid people in climbing in and out of bathtubs. In some such solutions, a bracket clamps on the inside and outside of the bathtub and comprises a handle for a person to hold and thereby steady oneself. In other solutions, a handle is anchored into the side of the bathtub by screws or other fasteners. However, these handles may come loose over time and/or with continued use. Further, these other approaches may be obtrusive to the decor of the bathroom.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 depicts an installed bathtub post according to one embodiment of the present disclosure;

FIG. 2 depicts an uninstalled bathtub post according to one embodiment of the present disclosure;

FIG. 3 depicts an installation hardware component of a bathtub post according to one embodiment of the present disclosure;

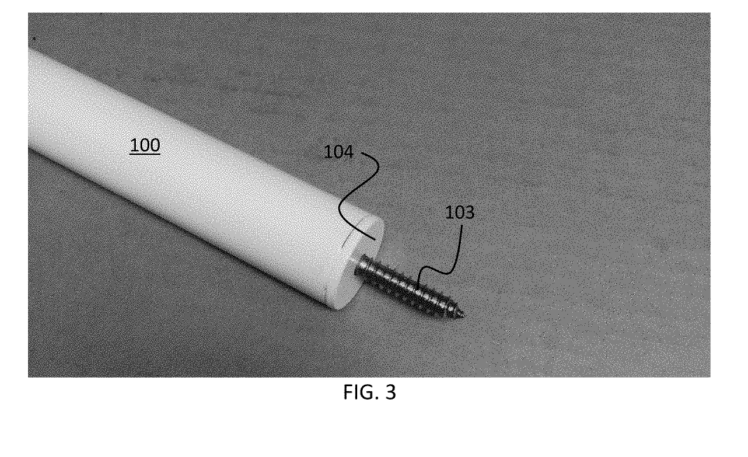

FIG. 4 depicts a hole for a bathtub post according to one embodiment of the present disclosure; and

FIG. 5 depicts a sectional view of an installation of a bathtub post according to one embodiment of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, reference is made to exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the spirit and scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples.

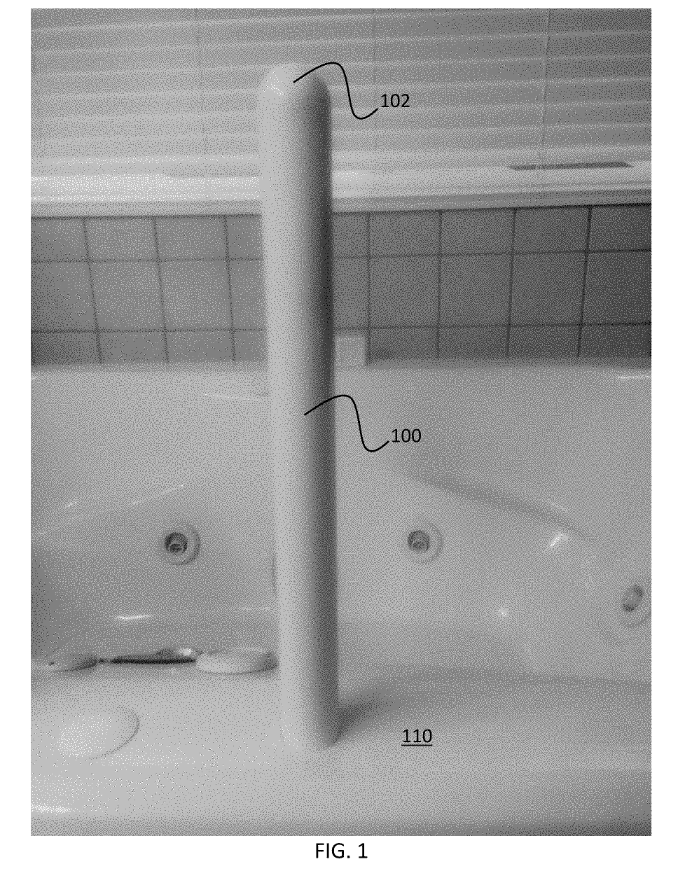

Embodiments of the present disclosure include a vertical post installed in or near a bathtub in order to provide a stable grip for a person to grab. Referring to FIG. 1, a vertical post 100 is installed in a hole that passes through a side cavity of a bathtub 110. In one embodiment, vertical post 100 comprises a round tube having a decorative top end 102. In one embodiment, decorative top end 102 comprises a domed rounded end.

In one embodiment, vertical post 100 is manufactured from tubular metal such as steel, stainless steel, aluminum, brass, titanium, nickel, other metals, or various alloys thereof. In some embodiments, vertical post 100 is manufactured from fiber glass, solid bar plastic, or wood. In other embodiments, vertical post 100 is manufactured from various combinations of the foregoing materials.

According to embodiments, vertical post 100 has a height of approximately 36 inches. In the present disclosure, the term “approximately” may be interpreted to mean at or within 5% of the stated value. In some embodiments, vertical post 100 is between 34 inches and 38 inches. According to various embodiments, the height of vertical post 100 may be varied according to the needs and comfort of any individual. According to some embodiments, the height of vertical post 100 may be varied according to intended installation factors, such as the size of the bathtub in which the vertical post 100 will be installed.

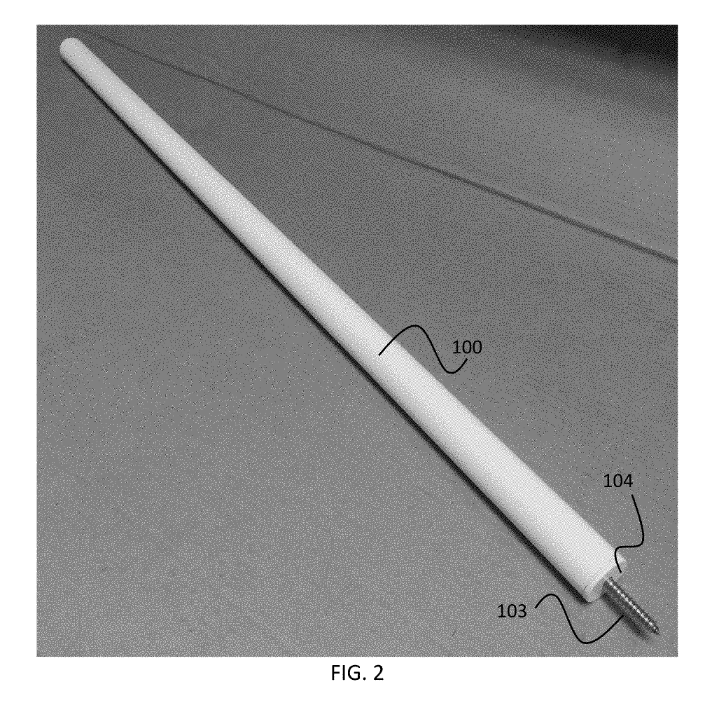

Referring to FIG. 2, embodiments of vertical post 100 comprises a lag bolt 103 protruding downward from its bottom end. In one embodiment, vertical post 100 comprises bottom end cap 104. In embodiments, other types of threaded fasteners may be utilized. In some embodiments, bottom end cap 104 is adapted to maintain lag bolt 103 rotationally fixed and vertically aligned with vertical post 100.

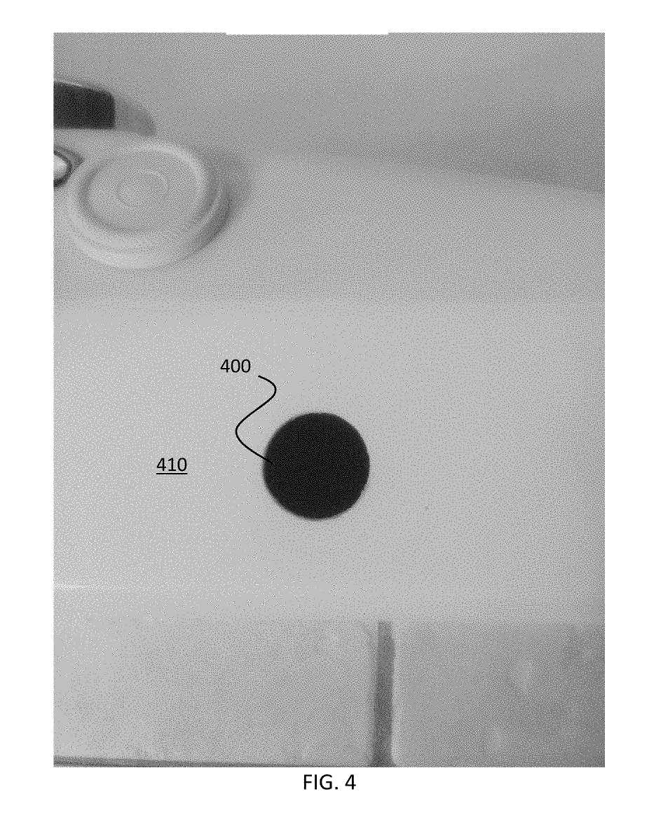

In operation, a vertical post according to embodiments of the present disclosure may be installed in various types of bathtubs. In one embodiment, a vertical post may be installed by drilling a hole in the top of the side cavity of the bathtub. The location of the hole may be selected where the vertical post may provide a convenient grip for one to hold while getting in or out of the bathtub. Referring to FIG. 4, hole 400 has been drilled through a horizontal surface 410 at the side of a bathtub, thereby providing access to the side cavity within the bathtub wall. In other embodiments, the hole 400 may be created by sawing a circular shape in the top surface above the cavity in the bathtub side wall.

According to embodiments, the diameter of the hole may be approximately the same diameter of the vertical post which is intended to be installed therein. In some embodiments, the hole diameter is slightly larger than the diameter of the vertical post. For example, in one embodiment, the hole diameter is approximately ⅛ inch large than the vertical post diameter. In various embodiments, the hole may be created using various means known in the art or not yet known in the art.

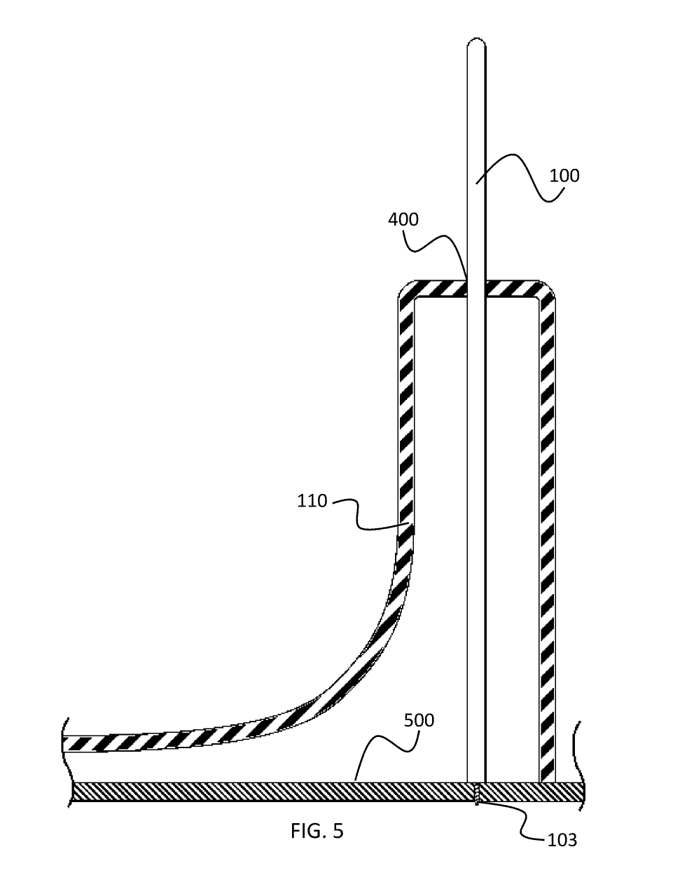

Following creation of the hole 400, the vertical post 100 may be inserted therethrough, with the bottom end having the lag bolt 103 inserted first. The vertical post 100 may be slid downward until the lag bolt 103 contacts the sub floor below the bathtub. Referring to FIG. 5, the vertical post 100 may then be held essentially vertical and rotated to screw the lag bolt 103 into sub floor 500. In the present disclosure, the term “essentially” may be interpreted to mean at or within 5% of the stated value. The lag bolt 103 may thus be twisted until the lag bolt 103 is securely and stably engaged with the subfloor 500. In embodiments, various types of adhesives may be applied to the lag bolt 103 prior to installation to prevent accidental and/or subsequent loosening of the lag bolt.

In embodiments, a water proof sealant may be applied to the hole circumference to prevent water leakage. In other embodiments, a gasket may be seated around the vertical post at the hole.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the spirit and scope of the present disclosure.

What is claimed is:

1. A bathtub grip comprising:
a post having a top end and a bottom end and
a threaded fastener rotationally fixed to the post, the fastener protruding from the bottom end and being in parallel alignment to the post.

2. The bathtub grip of claim 1, wherein the fastener comprises a lag bolt.

3. The bathtub grip of claim 1, wherein the fastener is engaged with a sub floor below a bathtub.

4. The bathtub grip of claim 1, wherein the post is partially encompassed within a side cavity of a bathtub.

5. The bathtub grip of claim 1, wherein a top portion of the post extends vertically above a bathtub.

6. The bathtub grip of claim 1, wherein the top end comprises a domed rounded end.

7. A method of installing a bathtub grip onto a bathtub comprising:
creating a hole having a hole diameter; thereby providing communication from a space above a side wall of the bathtub into a cavity within the side wall;
inserting a bottom end of the bathtub grip into the hole, the bathtub grip comprising:
a post having a top end, a bottom end, and a post diameter approximately equal to the hole diameter and
a threaded fastener rotationally fixed to the post, the fastener protruding from the bottom end and being in parallel alignment to the post;
moving the post downward until the fastener contacts a subfloor of the bathtub; and
rotating the post, thereby causing the fastener threads to engage with the subfloor.

8. The method of claim 7, further comprising applying an adhesive to the threaded fastener.

9. The method of claim 7, wherein rotating the post comprises maintaining the post in an essentially vertical orientation.

10. The method of claim 7, further comprising applying a sealant around a circumference of the post at the hole.

11. The method of claim 7, wherein creating the hole comprises drilling the hole.

12. The method of claim 7, wherein creating the hole comprises sawing the hole.
